(19) United States
(12) Patent Application Publication
(10) Pub. No.: US 2008/0028537 A1
(43) Pub. Date: Feb. 7, 2008

(54) Wire hooking tool

(76) Inventor: Victor Miles Tripp, Chapel Hill, NC (US)

Correspondence Address: Thomas J. Neagle;Neagle Law Firm, PC, Suite 104, 605 W. Main Street, Carrboro, NC, 27510, US

(21) Appl. No.: 11/799,509

(22) Filed: May 2, 2007

Related U.S. Application Data
(60) Provisional application No. 60/835,399, filed on Aug. 3, 2006.

(51) Int. Cl. B25B 25/00

(52) U.S. Cl. 7/108; 140/102

(57) ABSTRACT

A multi-purpose tool comprising a handle, and a safety tube having a connecting end coupled to the handle and a working end that receives a spring element. Wall edges at the working end define an outer rim. The safety tube has a bit assembly housing at the working end that secures a bit assembly within the safety tube. The tool further comprises a wire rotation means for rotating a wire clockwise and counterclockwise around a fastener shank. The working end of the safety tube surrounds a fastener head thus providing additional rotational support. The present tool is able to tighten and loosen a fastener such as a screw, and optionally and simultaneously hook and unhook the wire around the fastener shank. The tool may also be used for tightening and loosening the fastener without engaging the wire rotation means.

### CROSS-REFERENCE TO RELATED APPLICATIONS

This application claims the benefit of Provision Patent Application Ser. No. 60/835,399, filed 2006 Aug. 3 (Attorney Docket No. P20060803).

### BACKGROUND OF INVENTION

1. Field of the Invention

The present invention relates to a screwdriver, and more particularly to a multi-purpose tool for tightening and loosening a fastener with an additional support, and for optionally and simultaneously hooking and unhooking a wire around the fastener.

2. Relevant Background

A wire is hooked and unhooked around a fastener such as a screw in many different applications and in many different fields of work. Those who typically perform the hooking and unhooking functions include, without limitation, service technicians and other individuals who perform installations, repairs and upgrades to electrical outlets, plumbing fixtures and household appliances. Often, the fastener that secures the wire requires tightening while simultaneously hooking the wire followed by further tightening once the wire is completely hooked such as when wiring electrical switches and receptacles, pump switches, light fixtures, picture frames, speaker connections, and drop ceiling supports. Similarly, removing a hooked wire requires loosening the fastener while unhooking the wire followed by further loosening. In many of these examples, the wire must be hooked in such a way so as to sufficiently hold against a surface and make contact with the fastener. In the case of an electrical application, it is particularly important that the wire is hooked properly to make a good contact in order to prevent the wire from becoming loose and causing electrical failure and fire.

At the present time, hooking the wire around the fastener is typically accomplished by placing the wire in a hole on a pair of electrical wire stripping pliers, bending the wire in a U-shape, hooking the wire onto the fastener, crimping the wire to a shank of the fastener by using a pair of pliers, and tightening the fastener against a surface such as an electrical terminal by using a screwdriver. Another method involves bending the wire with a pair of pliers into a U-shape, hooking the wire, crimping the wire to the shank of the fastener by pushing the screwdriver against it, and tightening the fastener with the screwdriver. Both of these methods are adequate, however, they are also time consuming and can be dangerous if the screwdriver slips off of the fasteners.

Additionally, it is difficult for people to tighten or loosen the fastener in two general scenarios, with and without the requirement of hooking and unhooking the wire: (i) when space around the fastener is limited which often occurs with working with a hose clamp; and (ii) when the fastener is recessed to a depth that makes it difficult for a screwdriver bit tip to hold to a fastener head sufficiently, thus causing the screwdriver tip to slip off.

It is, therefore, desirable to provide an improved tool which overcomes most, if not all, of the preceding problems.

### SUMMARY

The present invention is directed to a multi-purpose tool that satisfies these needs. A multi-purpose tool having features of the present invention comprises a handle, a safety tube, a spring element, a bit assembly, and a wire rotation means.

The handle defines a longitudinal axis, and has a connecting end.

The safety tube has a connecting end coupled with the connecting end of the handle, and a working end at an opposite end. The safety tube comprises:

(a) safety tube interior walls;

(b) a bit assembly housing defined by at least a portion of the safety tube interior walls that is at the working end of the safety tube. The bit assembly housing has an inner housing end that is between the connecting end of the safety tube and the working end, the bit assembly housing comprising a securing hollow extending outwardly from the inner housing end; and

(c) wall edges at the working end defining an outer rim.

The spring element has a first end adjacent to the inner housing end and a second end at an opposite end. The bit assembly housing is capable of receiving the spring element at the working end.

The bit assembly comprises a bit element coupled with the second end of the securing member. The bit assembly may also have a securing member having a first end adjacent to the second end of the spring element and a second end at an opposite end. The securing member has a shape and size that is complementary to a shape and size of the securing hollow wherein the securing hollow is capable of receiving and securing the securing member such that the bit assembly rotates as the safety tube is rotated; and

The wire rotation means is adapted for engaging a wire and rotating the wire clockwise and counterclockwise around a fastener shank.

The bit assembly may have a spring guide capable of being received by the spring element. The bit element may have a bit shaft and a bit tip. The bit element may be a phillips head or other than a phillips head. The bit tip is adapted for engaging a fastener head for rotating a fastener.

The bit shaft may be magnetic for a known length, and the securing member may have a magnetic bit element securing hollow having an interior surface contoured for engagement with a known length of the bit shaft; the bit shaft may show a magnetic attraction to the magnetic bit element securing hollow such that the magnetic bit element securing hollow holds the bit element when engaged.

The spring element may be supported by a solid core portion of the safety tube thereby providing support for the spring element such that the spring element and spring guide do not extend inwardly beyond the inner housing end.

The inner circumference of the outer rim may be of a predetermined shape and size sufficient to surround the fastener head so as to provide additional support to prevent a bit tip from slipping off the fastener head as the safety tube and the fastener are rotated.

The wire rotation means may include a tooth member protruding longitudinally beyond the outer rim. The tooth member may be substantially rectangular in shape, and is capable of engaging and rotating the wire clockwise and counterclockwise around the fastener shank when a pressure is exerted on the handle toward the fastener thereby compressing the spring element and recessing the bit assembly inwardly. The tooth element may also be used as a flat screwdriver for tightening or loosening a receptacle plate screw.

### REFERENCE NUMBERS IN THE DRAWINGS

#
18 Longitudinal axis
20 Handle
22 Connecting end (of handle)
30 Safety tube
32 Connecting end (of safety tube)
34 Working end (of safety tube)
35 Solid core portion (of safety tube)
36 Safety tube interior walls
38 Inner housing end
42 Outer rim
48 Circular threaded bore (in bit shaft)
50 Bit assembly housing
52 Securing hollow
54 Non-securing hollow
56 Proximal end (of securing hollow)
58 Distal end (of securing hollow)
64 Spring element
65 First end (of spring element)
66 Second end (of spring element)
70 Bit assembly
72 Spring guide
74 Proximal end (of spring guide)
76 Distal end (of spring guide)
78 Hollow (at second end of spring element)
82 Securing member (of bit assembly)
84 First end (of securing member)
86 Second end (of securing member)
88 Bit element
90 Bit shaft
92 First end (of bit shaft)
94 Second end (of bit shaft)
96 Bit shaft groove
98 Circular threaded hole (in safety tube)
100 Stop pin
102 Bit
104 Connecting end (of bit)
106 Bit tip (of bit)
108 Magnetic bit element securing hollow (of securing member)
110 Tooth member
130 A circumference (of the safety tube inner walls less than a circumference of an outer perimeter of spring element)
132 Stop pin slit
140 Safety tube slit
142 Longitudinal grooves (of safety tube slit)
144 Retractable adjustment device
146 Knob end (of retractable adjustment device)
148 Circular tube end (of retractable adjustment device)
150 Circular tube
154 Adjustment knob
156 Snap ring
160 Snap ring groove
172 Retractable tooth
173 Flat side (of retractable tooth)
174 Connecting end (of retractable tooth)
175 Narrow sides (of retractable tooth)
178 Solid pin
180 Positioning slit
182 Positioning slit notches
184 Strap spring
186 Retractable tooth bit tip
188 Inner wall indentations
190 Strap spring support
192 Small ridges
194 Depth gauge
196 Handle markings
198 Tapered end
200 Band
202 First band restricting hollow
204 Band slide hollow
210 Second band restricting hollow
218 First bit guide slot
220 Second bit guide slot
225 Flat head screwdriver bit shaft
226 Flat head screwdriver bit tip
227 Narrow opposing sides (of flat head screwdriver bit tip)
228 Flat head screwdriver bit

### BRIEF DESCRIPTION OF THE DRAWINGS

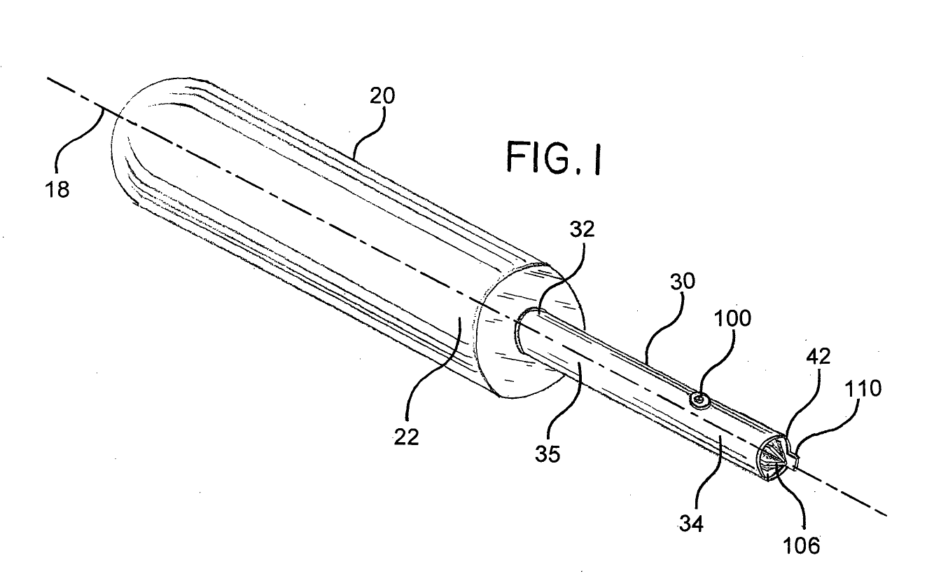

FIG. 1 is a perspective longitudinal view of the wire hooking tool in accordance with the one embodiment of the present invention.

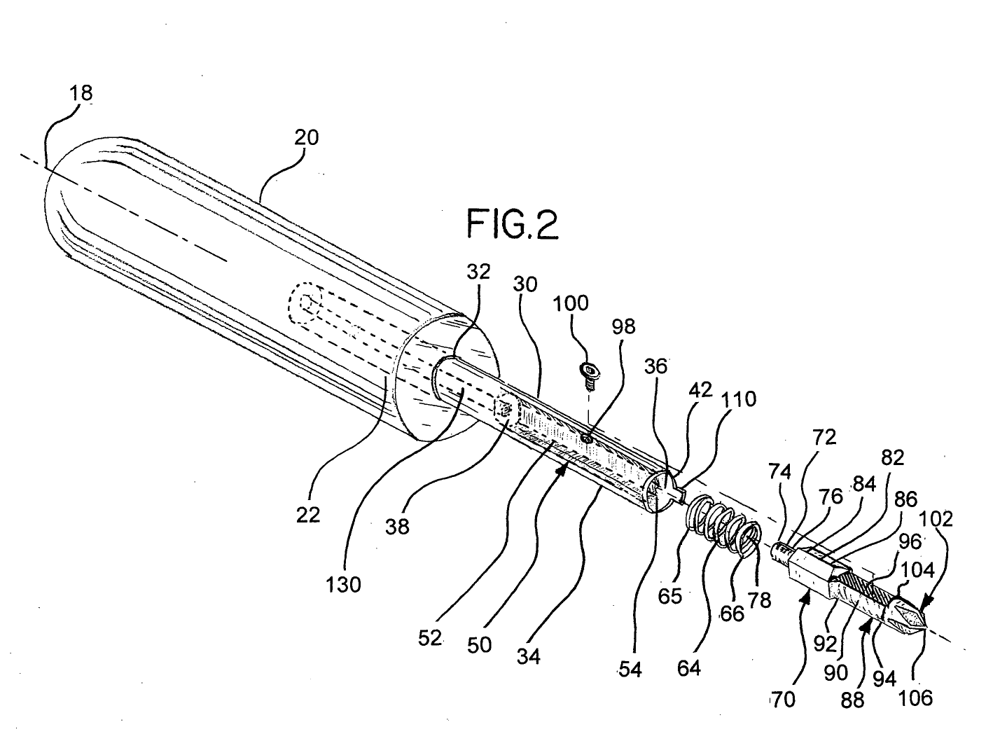

FIG. 2 is an exploded perspective view of the wire hooking tool of FIG. 1.

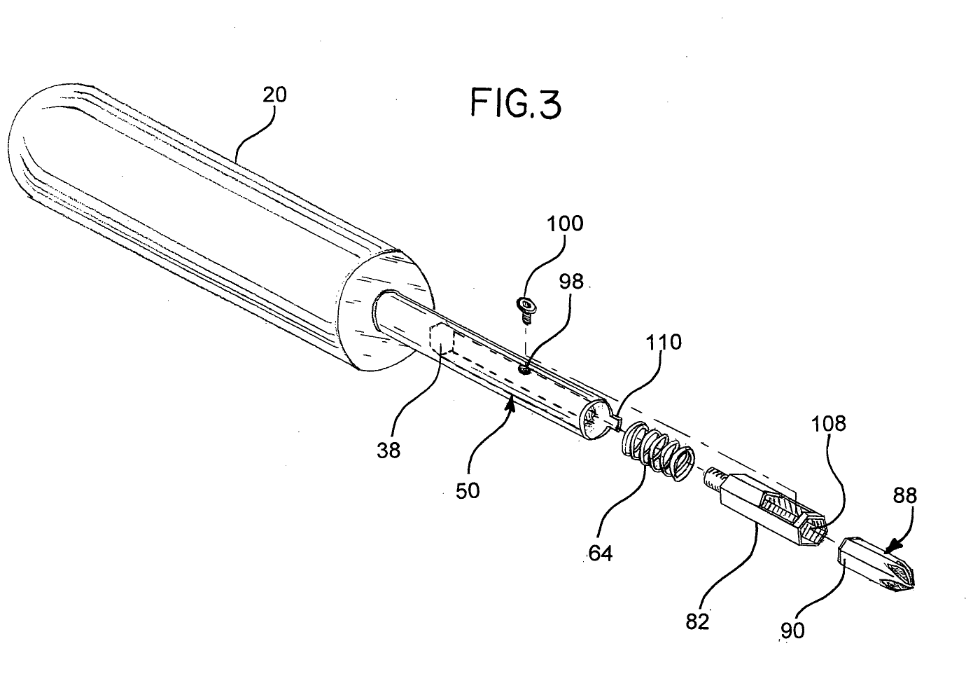

FIG. 3 is an exploded perspective view of the wire hooking tool showing a magnetic bit assembly designed to accept interchangeable and alternative bits, in accordance with an alternative embodiment of the present invention.

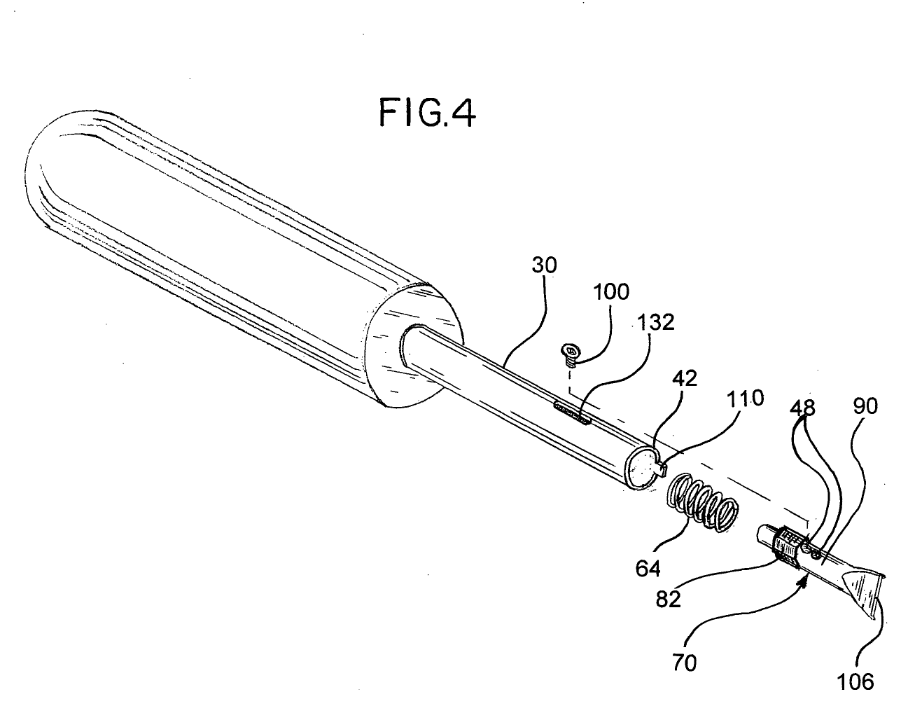

FIG. 4 is an exploded perspective view of the wire hooking tool showing a stop pin slit in a safety tube and a plurality of circular threaded bore in a bit shaft in accordance with an alternative embodiment of the present invention.

FIG. 5 is an exploded perspective view of the wire hooking tool showing a retractable tooth design, in accordance with an alternative embodiment of the present invention.

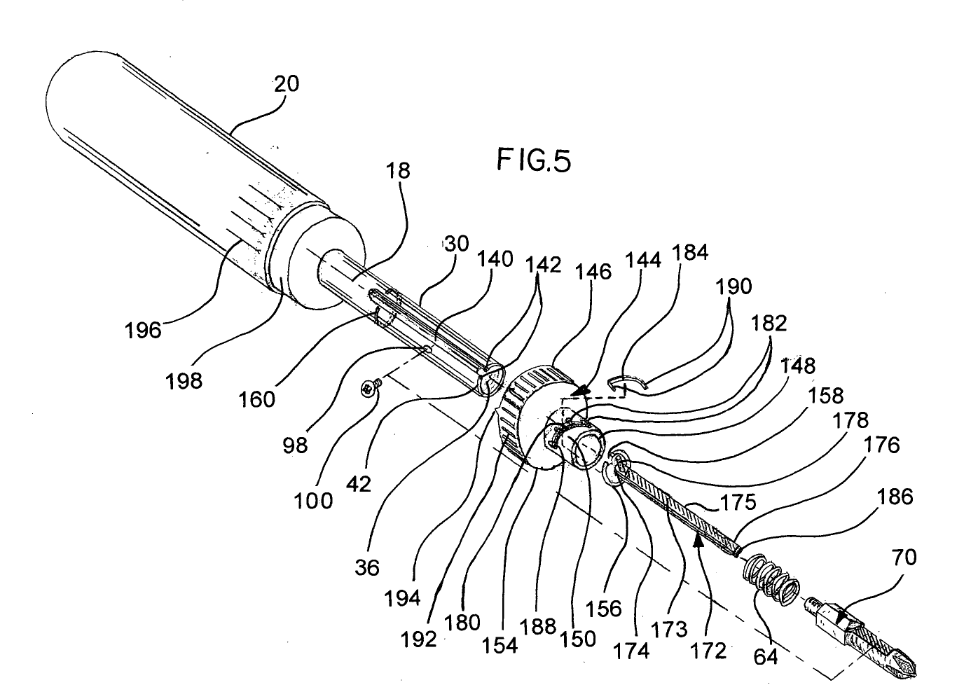

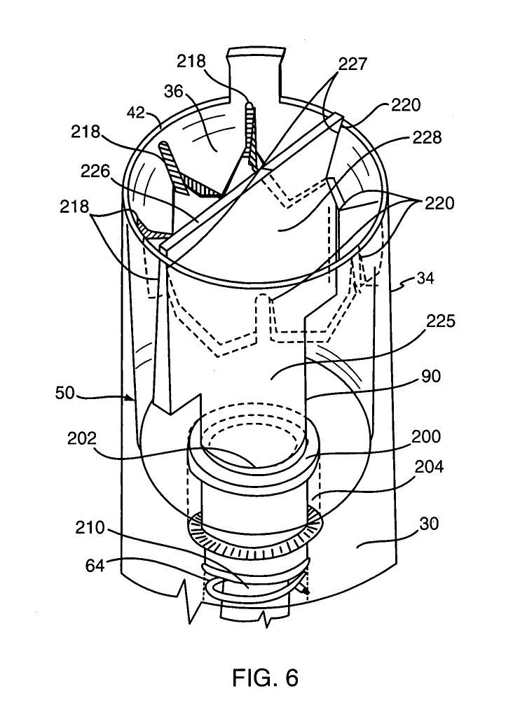

FIG. 6 is an exploded perspective sectional view of the working end of the safety tube showing a restricting hollow without a stop pin in accordance with an alternative embodiment of the present invention.

FIG. 7 is a front elevation sectional view of a safety tube of the wire hooking tool in FIG. 4 with a bit inserted into a top of a fastener and a wire against a shank of a fastener.

FIG. 8 is a top view of a hollow end of the safety tube of FIG. 7.

FIG. 9 is a front elevation sectional view of a safety tube of the wire hooking tool in FIG. 4 with a bit inserted into a fastener head, the safety tube surrounding the fastener head, and a tooth at a hollow end of the safety tube holding a wire against a fastener shank.

FIG. 10 is a top view of a hollow end of the safety tube of FIG. 9.

FIG. 11 is a front elevation sectional view of a safety tube of the wire hooking tool in FIG. 4 with a bit inserted into a fastener head, the safety tube surrounding the fastener head, and a tooth at a hollow end of the safety tube bending a wire around a fastener shank at approximately a 50 degree angle while the a fastener is being tightened.

FIG. 12 is a top view of a hollow end of the safety tube of FIG. 11.

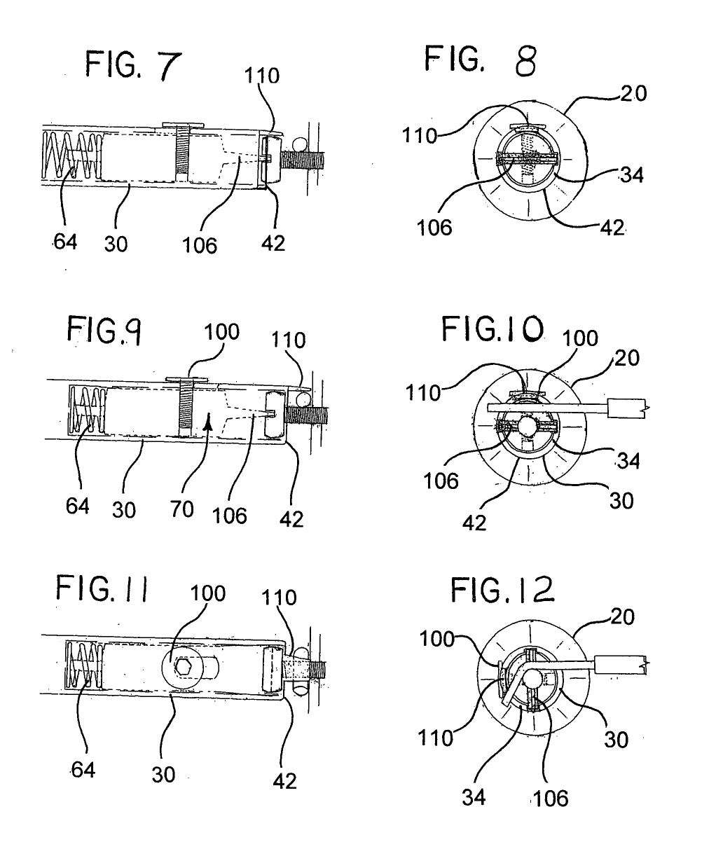

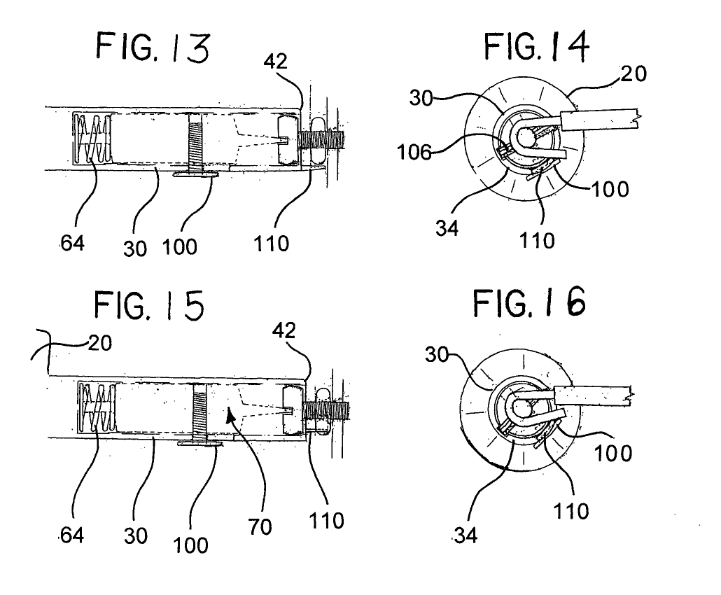

FIG. 13 is a front elevation sectional view of a safety tube of the wire hooking tool in FIG. 4 with a bit inserted into a fastener head, a safety tube surrounding the fastener head, and a tooth at a hollow end of the safety tube bending the wire around a fastener shank beyond 90 degrees while the a fastener is being tightened.

FIG. 14 is a top view of a hollow end of the safety tube of FIG. 13.

FIG. 15 is a front elevation sectional view of a safety tube of the wire hooking tool in FIG. 4 with a bit inserted into a fastener head, the safety tube surrounding the fastener head, and a wire completely hooked around a fastener shank.

FIG. 16 is a top view of a hollow end of the safety tube of FIG. 15.

It is to be understood that, in this description and in the appended claims, all references to a wire pertains to an electrical wire, a telephone wire, a computer wire, an automobile wire, a vehicle wire, an airplane wire, an appliance wire, an equipment wire, a stereo speaker wire, a multi-strand wire, a combination of wires, a strand, a cloth strip, a thread strip, a fiber strip, a metal strip, and a combination of strips; and, all references to fastener pertains to a screw, a dowel and a bolt.

It is to be understood that the present invention is not limited in its application to the details of the construction and arrangement of parts illustrated in the accompanying drawing, since the invention is capable of other embodiments and of being practiced or carried out in various ways within the scope of the present invention. For example, a plurality of materials of construction may be employed, as well as a plurality of types of tool bits defining numerous types of tool heads currently known or that later become known, may equally be employed. It is to be understood that the present invention includes construction utilizing metric measurements. Also, it is also to be understood that the phraseology and terminology employed herein is for the purpose of description, and not of limitation.

### DETAILED DESCRIPTION

For purposes of the discussion of the present invention, the following glossary applies:

Wire: an electrical wire, a telephone wire, a computer wire, an automobile wire, a vehicle wire, an airplane wire, an appliance wire, an equipment wire, a stereo speaker wire, a multi-strand wire, a combination of wires, a strand, a cloth strip, a thread strip, a fiber strip, a metal strip, a combination of strips.

Fastener: a screw, a dowel, a bolt.

As shown in FIG. 1 and FIG. 2, the wire-hooking tool comprises a handle 20 along a longitudinal axis 18 and a safety tube 30 attached to the handle 20. The handle 20 may be electrically insulated and may have a cylindrical shape or another shape suitable for gripping and rotating. The handle 20 may be made of impact resistant plastic, wood, or any appropriate material. In one embodiment, the handle 20 is about 102 mm (approximately 4 inches) in length, and about 38 mm (approximately 1½ inch) in diameter. The handle 20 has a connecting end 22. In alternate embodiments, the handle 20 may be any device or attachment that is capable of accomplishing its intended purposes of gripping, rotating, pulling and pushing the safety tube 30.

The safety tube 30 has a connecting end 32 at one end, and a working end 34 at an opposite end. In the preferred embodiment, the safety tube 30 is cylindrical in shape. The safety tube 30 may be made of metal, iron or steel, or any appropriate material including, without limitation, other alloys. The safety tube 30 may have an outside diameter of about 11 mm (approximately 7/16 inch), and a length of about 152 mm (approximately 6 inches).

The safety tube 30 may extend longitudinally outwardly from the handle 20. The connecting end 32 of the safety tube 30 may be coupled with the connecting end 22 of the handle 20. In the preferred embodiment, the connecting end 22 of the handle 20 is molded around the safety tube 30 at the connecting end 32 with safety tube 30 extending through the handle 20 approximately 76 mm (approximately 3 inches). In an alternate embodiment, the connecting end 22 of the handle 20 has a female socket of suitable size and shape to receive a male attachment at the connecting end 32 of the safety tube 30. In an alternate embodiment, the connecting end 32 of the safety tube 30 has a female socket of suitable size and shape to receive a male attachment at the connecting end 22 of the handle 20.

The safety tube 30 may comprise safety tube interior walls 36 having one or more interior shapes and one or more interior sizes, and a bit assembly housing 50 defined by at least a portion of the safety tube interior walls 36 at the working end 34.

The bit assembly housing 50 may have an inner housing end 38 that is between the connecting end 32 of the safety tube 30 and the working end 34. The bit assembly housing 50 may extend from the inner housing end 38 outwardly. Wall edges at the working end 34 form an outer rim 42. In the preferred embodiment, the inner housing end 38 is about 47 mm (approximately 1⅞ inches) from the outer rim 42. The bit assembly housing 50 may have a securing hollow 52. The securing hollow 52 may have a proximal end adjacent to the inner housing end 38 and a distal end. The securing hollow 52 may extend from the inner housing end 38 outwardly about 38 mm (approximately 1½ inches). In the preferred embodiment, the securing hollow 52 is hexagon-shaped. In other embodiments, the securing hollow 52 may be other shapes including, without limitation, square and octagonal shapes. The diameter of the securing hollow 52 may be about 8 mm (approximately 5/16 inch).

The bit assembly housing 50 may also have a non-securing hollow 54. The non-securing hollow 54 may extend from the distal end of the securing hollow 52 outwardly about 10 mm (approximately ⅜ inch) to the outer rim 42. In the preferred embodiment, the non-securing hollow 54 is circular and has a diameter of about 10 mm (approximately ⅜ inch).

In the preferred embodiment, the bit assembly housing 50 receives a spring element 64 at the working end 34. The spring element 64 may be a cylindrically shaped tension coil type spring, and may be made of any material capable of providing the required tension including, without limitation, spring steel. The spring element 64 may have a diameter of about 8 mm (approximately 5/16 inch) or any other diameter sufficient to fit inside the bit assembly housing 50. The spring element 64 may be about 19 mm (approximately ¾ inch) in length when fully coiled, and about 16 mm (approximately ⅝ inch) when assembled within the safety tube 30 with no forward pressure exerted on the safety tube 30. In the preferred embodiment, the spring element 64 compresses to about 6 mm (approximately ¼ inch) when forward pressure is applied to the safety tube 30, and recoils back to about 16 mm (approximately ⅝ inch) when forward pressure is released.

In the preferred embodiment, the spring element 64 has a first end 65 adjacent to the inner housing end 38 and a second end 66 at an opposite end. The bit assembly housing 50 may be capable of receiving the spring element 64.

In the preferred embodiment, a bit assembly 70 is accepted by the bit assembly housing 50. The bit assembly 70 may be a single welded piece made of metal. In alternative embodiments, the bit assembly 70 may be made of iron or steel, other alloys, or other appropriate materials. The bit assembly 70 may be about 40 mm (approximately 1 9/16 inches) in length. The bit assembly 70 may comprise a securing member 82 and a bit element 88.

In the preferred embodiment, the securing member 82 has a shape and size that is complementary to a shape and size of the securing hollow 52, wherein the securing hollow 52 is capable of receiving and securing the securing member 82 such that the bit assembly 70 rotates as the safety tube 30 is rotated. The securing member 82 may extend longitudinally about 11 mm (approximately 7/16 inch). The securing member 82 may have a diameter of about 8 mm (approximately 5/16 inch), and may be hexagonal in shape. The securing member 82 may have a first end 84 adjacent to the second end 66 of the spring element 64 and a second end 86 at an opposite end.

The bit element 88 may be coupled with the second end 86 of the securing member 82. The bit element 88 may comprise a bit shaft 90, and a bit 102. The bit shaft 90 may be an elongated member and extend longitudinally from the second end 86 of the securing member 82 outward. The bit shaft 90 has a first end 92 that may be coupled with the second end 86 of the securing member 82, and a second end 94 at an opposite end. In the preferred embodiment, the bit shaft 90 is approximately about 14 mm (approximately 9/16 inch) in length, and is substantially circular in shape, with a diameter of about 6 mm (approximately ¼ inch).

In the preferred embodiment, the bit 102 has a connecting end 104 coupled with the second end 94 of the bit shaft 90, and a bit tip 106 at an opposite end. The bit tip 106 may be adapted for engaging a fastener head for rotating the fastener. The bit tip 106 may be a phillips head. The bit tip 106 may also be other than phillips head. Alternative embodiments of the bit tip 106 include, without limitation, other types and sizes of bits such as other hex, star, square, flat, slotted, robertson, torx, and cross-head. In one embodiment, the bit tip 106 protrudes out from the outer rim 42 of the safety tube 30 about 1 mm (approximately 1/32 inch).

The outer rim 42 may surround the fastener head thus providing additional support to prevent the bit tip 106 from slipping off the fastener head.

In the preferred embodiment, the bit shaft 90 has a bit shaft groove 96 extending longitudinally on the bit shaft 90 beginning from about 6 mm (approximately ¼ inch) from the bit tip 106 inwardly for about 14 mm (approximately 9/16 inch). The bit shaft groove 96 may have a depth of about 2 mm (approximately 1/16 inch). A wall of the safety tube 30 may have a circular threaded hole 98 with a center positioned about 19 mm (approximately ¾ inch) from the working end 34. The circular threaded hole 98 may have a diameter of about 3 mm (approximately ⅛ inch) and a length of about 3 mm (approximately ⅛ inch). A stop pin 100 may have an elongated threaded member with a shape and size complementary to a shape and size of the circular threaded hole 98 and complementary to a shape and size of the bit shaft groove 96. The stop pin 100 may be threaded through the circular threaded hole 98 and protrude into the bit shaft groove 96 about 2 mm (approximately 1/16 inch), which may cause the spring element 64 to compress to about 16 mm (approximately ⅝ inch) without pressure exerted on the handle 20. The stop pin 100 may be made of steel or some other material suitable to allow the bit assembly 70 to slide longitudinally in and out as the spring element 64 compresses and recoils to the extent the stop pin 100 slides within the bit shaft groove 96, but no further.

The bit assembly 70 may also comprise a spring guide 72. The spring guide 72 may have a proximal end 74 and a distal end 76 at an opposite end. The spring guide 72 may be an elongated member, cylindrical in shape. In the preferred embodiment, the spring guide 72 is about 6 mm (approximately ¼ inch) in length. The spring guide 72 may have a predetermined diameter such that the spring guide 72 is capable of fitting into a hollow 78 at the second end 66 of the spring element 64. The spring guide 72 may have a diameter of about 5 mm ( 3/16 inch). The distal end 76 of the spring guide 72 may be coupled with the first end 84 of the securing member 82.

The tool may have a wire rotation means that is adapted for engaging the wire and rotating the wire clockwise and counterclockwise around a fastener shank. The wire rotation means may be adapted to engage different types of wires including without limitation an electrical wire, a telephone wire, a computer wire, an automobile wire, a vehicle wire, an airplane wire, an appliance wire, an equipment wire, a stereo speaker wire, a multi-strand wire, a combination of wires, a strand, a cloth strip, a thread strip, a fiber strip, a metal strip, and a combination of strips

The wire rotation means may include a tooth member 110 that is substantially rectangular in shape. The tooth member 110 may be aligned with a concavity of the outer rim 42 for about 3 mm (approximately ⅛ inch), and may protrude longitudinally outwardly beyond the outer rim about 2 mm (approximately 3/32 inch) such that the tooth member 110 is capable of catching and rotating the wire clockwise and counterclockwise around the fastener shank as said safety tube is rotated and a pressure is exerted on the handle 20 toward the fastener thereby compressing the spring element 64 and recessing the bit assembly 70 inwardly. The tooth element 110 may be made of metal, iron or steel, or their alloys, but other materials can be used if desired. In the preferred embodiment, the tooth element 110 is cast with the same material used for the safety tube 30. In alternative embodiments, the tooth element 110 is welded to the outer rim 42 or otherwise coupled to the safety tube 30 such that the tooth element 110 is capable of extending beyond the outer rim 42.

In the preferred embodiment, the safety tube 30 has a solid core portion 35 extending longitudinally from the connecting end 32 of the safety tube 30 outwardly to the inner housing end 38 thus providing support for the spring element 64 so that the spring element 64 will not extend inwardly beyond the inner housing end 38. In another embodiment shown in FIG. 2, a circumference 130 of the safety tube inner walls 36 extending from the connecting end 32 of the safety tube 30 outwardly to the inner housing end 38 is less than a circumference of an outer perimeter of the spring element 64, thereby providing support for the spring element 64 so that the spring element 64 will not extend inwardly beyond the inner housing end 38.

FIG. 3 is an exploded perspective view of the wire hooking tool showing an alternative embodiment with the securing member 82 having a magnetic bit element securing hollow 108 with an interior surface contoured for engagement with a known length of the bit shaft 90. The bit shaft 90 may show a magnetic attraction to the magnetic bit element securing hollow 108 such that the magnetic bit element securing hollow 108 holds the bit element 88 when engaged. The bit element 88 may be interchangeable and may have a plurality of bit types, shapes and sizes. The magnetic securing hollow 108 may also receive, without limitation, ratchets with interchangeable bits. The magnetic bit element securing hollow 108 may be about 6 mm (approximately ¼ inch) in diameter and may have a hexagonal shape.

The bit tip 106 may show a magnetic attractive to the fastener head such that the bit tip 106 better holds to the fastener head.

### Sliding Stop Pin

FIG. 4 is an exploded perspective view of one embodiment of the wire hooking tool with the stop pin 100 and at least one circular threaded bore 48. As shown in FIG. 4, a stop pin slit 132 extends longitudinally in a wall of the safety tube 30. The stop pin slit 132 may begin about 17 mm (approximately 21/32 inch) from the outer rim 42 and extend inwardly about 13 mm (approximately ½ inch). The stop pin slit 132 may be about 5 mm (approximately 3/16 inch) in width or any width sufficient such that the stop pin 100 can be inserted through it.

In one embodiment, the circular threaded bore 48 located in the bit shaft 90. The circular threaded bore 48 may have a diameter of about 3 mm (approximately ⅛ inch), and a depth sufficient to allow the stop pin 100 to hold to the bit element 88 when the stop pin 100 is threaded into it. A center of the circular threaded bore 48 may be located about 21 mm (approximately 13/16 inch) from an end of the bit tip 106.

In one embodiment, the stop pin 100 has an elongated threaded member that has a shape and size complementary to a shape and size of the stop pin slit 132 and the circular threaded bore 48. The stop pin 100 may extend through the stop pin slit 132 and be threaded into the circular threaded bore 48 thus allowing a longitudinal movement of the bit assembly 70 to an extent the stop pin 100 slides within the stop pin slit 132, which may be approximately 10 mm (or ⅜ inch).

In one embodiment, the bit shaft 90 has more than one circular threaded bore 48 to allow the bit assembly 70 to extend both outwardly and inwardly based on the circular threaded bore 48 that is chosen for threading by the stop pin RETRACTABLE TOOTH DESIGN

FIG. 5 is an alternative embodiment of the wire hooking tool with a retractable adjustment design. The safety tube 30 may have a safety tube slit 140, a retractable adjustment device 144, a snap ring 156 capable of securing the retractable adjustment device 144 against the handle 20, and a wire rotation means.

In one embodiment, the safety tube slit 140 extends longitudinally about 70 mm (approximately 2¾ inches) inwardly from the outer rim 42. The safety tube slit 140 may have a width of about 3 mm (approximately ⅛ inch). The safety tube slit 140 may have longitudinal grooves 142 along both sides. The retractable adjustment device 144 may have a knob end 146 and a circular tube end 148 at an opposite end. The retractable adjustment device 144 may be made of hard plastic, metal, iron or other alloys or materials suitable for its purpose.

The retractable adjustment device 144 may comprise a circular tube 150 extending from the circular tube end 148 inwardly, and an adjustment knob 154. The circular tube 150 may have interior walls having a shape and size that is complementary to a shape and size of exterior walls of the safety tube 30 such that the circular tube 150 fits snugly around the safety tube 30. In one embodiment, the circular tube 150 has an outer diameter of about 22 mm (approximately ⅞ inch), and may be about 19 mm (approximately ¾ inch) in length. A hollow of the circular tube 150 may have a diameter of about 11 mm (approximately 7/16 inch).

The adjustment knob 154 may be coupled at one end to the circular tube 150 and at an opposite end to the handle 20, which may be tapered. The adjustment knob 154 may be circular in shape and its outer perimeter may have diameter of about 32 mm (approximately 1¼ inch). The adjustment knob 154 may extend longitudinally about 13 mm (approximately ½ inch). The adjustment knob 154 may have small ridges 192 to aid in gripping.

The safety tube 30 may have a snap ring groove 160 extending transversely around the safety tube 30. The snap ring 156 may have an opening that is complementary to the safety tube slit 140. The snap ring 156 may also have a shape and size that is complementary to the snap ring groove 160 such that the snap ring groove 160 is capable of receiving the snap ring 156 and securing the retractable adjustment device 144 to the handle 20. The snap ring groove 160 may extend transversely approximately 54 mm (2⅛ inches) from the outer rim 42, may be about 2 mm (approximately 1/16 inch) in width, and may extend about 0.4 mm (approximately 1/64 inch) into the outer wall of the safety tube 30. The adjustment knob 154 may be held against the handle 20 by the snap ring 156 which may be received by the snap ring groove 160.

In one embodiment, the wire rotation means comprises a retractable tooth 172. The retractable tooth 172 may have a connecting end 174 and a retractable tooth bit tip 186 at an opposite end. The retractable tooth 172 may have a flat side 173 and narrow sides 175 adjacent to the flat side 173. The retractable tooth 172 may be elongated and substantially rectangular in shape, and have a thickness that is complementary to a width of the longitudinal grooves 142. The retractable tooth 172 may be made of metal, iron or steel, or other alloys, but other materials can also be used if desired. In one embodiment, the retractable tooth 172 is about 70 mm (approximately 2¾ inches) in length and about 3 mm (approximately ⅛ inch) in width. The narrow sides 175 of the retractable tooth 172 may fit into the longitudinal grooves 142, and may slide longitudinally along the longitudinal grooves 142. The retractable tooth 172 may have a solid pin 178 coupled perpendicularly to the flat side 173 at the connecting end 174. The solid pin 178 may be about 2 mm (approximately 3/32 inch) in diameter and about 5 mm (approximately 3/16 inch) in length. The center of the solid pin 178 may be about 2 mm (approximately 1/16 inch) from the connecting end 174. The retractable tooth bit tip 186 may comprise a plurality of bit types, shapes and sizes. In one embodiment, the adjustment knob 154 may have a depth gauge 194 that correlates with handle markings 196 indicating the extent to which the retractable tooth 172 is extended.

In one embodiment, a positioning slit 180 extends obliquely in the circular tube 150 at about a 22 degree angle or other angle sufficient to support its intended purposes of receiving the solid pin 178, pushing and pulling the solid pin 178 along the longitudinal axis 18 as the adjustment knob 154 is rotated, thereby allowing the retractable tooth 172 to extend outwardly and inwardly. In one embodiment, the positioning slit 180 is about 13 mm (approximately ½ inch) in length and about 3 mm (approximately ⅛ inch) in width.

The positioning slit 180 may have a plurality of positioning slit notches 182 in a side edge near the adjustment knob 154 to hold the solid pin 178 at a desired setting. The positioning slit notches may indent about 1 mm (approximately 1/32 inch)

In one embodiment, a strap spring 184 is received on an interior of the positioning slit 180. The strap spring 184 may maintain tension on the solid pin 178 thus securing the solid pin 178 in the positioning slit notches 182. The strap spring 184 may be about 13 mm (approximately ½ inch) in length, about 3 mm (approximately ⅛ inch) in width, and about 1 mm (approximately 1/32 inch) in thickness. The strap spring 184 may have a strap spring support 190 at each end. Each strap spring support 190 may extend about 2 mm (approximately 1/16 inch) from the ends of the strap spring 184 at about a 90 degree angle. The positioning slit 180 may have one or more inner wall indentations 188 in a side edge that may receive the strap spring support 190 to hold the strap spring 184 in place.

In one embodiment, rotation of the adjustment knob 154 moves the retractable tooth 172 longitudinally outwardly thus allowing the retractable tooth bit tip 186 to protrude beyond the outer rim 42 for hooking and unhooking wires. The adjustment knob 154 may also be rotated such that the retractable tooth 172 moves longitudinally inwardly, thereby permitting the tool to be used as a safety screwdriver without interference from the retractable tooth bit tip 186.

### Restricting Hollow without Stop Pin

FIG. 6 is an exploded perspective sectional view of the working end 34 of the safety tube 30 in accordance with an alternative embodiment of the present invention having a bit locking mechanism for a flat head screwdriver bit 228. The bit element 88 may have a flat head screwdriver bit shaft 225 at one end coupled to the distal end 76 of the spring guide 72, and a flat head screwdriver bit tip 226 at an opposite end. The flat head screwdriver bit shaft 225 may be an elongated member. The flat head screwdriver bit tip 226 may have a flat head that forms narrow opposing sides 227.

In one embodiment, a band 200 may be coupled transversely with an outer perimeter of the bit shaft 90 about 19 mm (approximately ¾ inch) from the outer rim 42.

The bit assembly housing 50 may further comprise a first band restricting hollow 202, a band slide hollow 204, a second band restricting hollow 210, and at least one pair of flat head bit guide slots, each pair of flat head bit guide slots having a first bit guide slot 218 and a second bit guide slot 220 on an opposite interior wall of the safety tube 30.

The first band restricting hollow 202 may have a proximal end and a distal end, extend inwardly for a predetermined distance from the outer rim 42, be substantially circular in shape, and have an inner circumference less than an outer circumference of the band 200 and greater than an outer circumference of the flat head screwdriver bit shaft 225. The first band restricting hollow 202 may begin about 17 mm (approximately 11/16 inch) from the outer rim 42 and may extend longitudinally inwardly about 2 mm (approximately 1/16 inch).

The band slide hollow 204 may have a distal end and a proximal end, and extends inwardly from the proximal end of the first band restricting hollow 202 for a predetermined distance. The band slide hollow 204 may begin about 19 mm (approximately ¾ inch) from the outer rim 42 and extend longitudinally inwardly about 11 mm (approximately 7/16 inch). The band slide hollow 204 may have an inner circumference at least as great as the outer circumference of the band 200 so that the band slide hollow 204 is capable of receiving the band 200.

The second band restricting hollow 210 may extend inwardly from the proximal end of the band slide hollow 204, and may be substantially circular in shape. The second band restricting hollow 210 may extend longitudinally inwardly about 17 mm (approximately 11/16 inch). The second band restricting hollow 210 may have an inner circumference less than the outer circumference of the band 200 and greater than the outer circumference of the flat head screwdriver bit shaft 225. Thus, the bit assembly 70 is restricted in movement to an extent that the band 200 is restricted between the first band restricting hollow 202 and the second band restricting hollow 210.

The first bit guide slot 218 and the second bit guide slot 220 extend longitudinally on the safety tube interior walls 36 inwardly from the outer rim 42. The first bit guide slot 218 and the second bit guide slot 220 each has a distal end near the outer rim 42 and a proximal end. The first bit guide slot 218 and the second bit guide slot 220 each has a size and shape complementary to a shape and size of the narrow opposing sides 227 of the flat head screwdriver bit tip 226 such that the proximal end of the first bit guide slot 218 and the proximal end of the second bit guide slot 220 are capable of receiving the narrow opposing sides 227 when the spring element is compressed. The outward extension of the flat head screwdriver bit 228 is limited to the extent that the movement of the band 200 is limited by second band restricting hollow 210, which may restrict extension of the bit element 88 to about 1 mm (approximately 1/32 inch) beyond the outer rim 42. The first bit guide slot 218 and the second bit guide slot 220 each may be about 6 mm (approximately ¼ inch) in length, about 3 mm (approximately ⅛ inch) in width, and about 2 mm (approximately 1/16 inch) deep.

### Operation of the Present Invention

FIG. 7 through FIG. 16 depict the operation of embodiments of the present invention.

FIG. 7 is a front elevation sectional view of the safety tube 30 of the wire hooking tool in FIG. 4. The bit tip 106 is inserted into the fastener head and the wire is at the side of the fastener shank. The outer rim 42 of the safety tube 30 surrounds the fastener head thus providing additional support to prevent the bit tip 106 from slipping off the fastener head. The spring element 64 is not compressed thereby allowing the tool to be used as a screwdriver with the additional support, without interference from the tooth member 110.

FIG. 8 is a top view of the working end 34 of FIG. 7.

FIG. 9 is a front elevation sectional view of the safety tube 30 of the wire hooking tool in FIG. 4 with the bit tip 106 inserted into the fastener head. The spring element 64 is compressed. The outer rim 42 encases the fastener head thus providing additional rotational support, the tooth member 110 holds the wire against the fastener shank, and the pressure of the outer rim 42 against the wire prevents the wire from slipping. From this position, the safety tube 30 can be turned clockwise and counterclockwise to tighten and loosen the fastener while simultaneously hooking and unhooking the wire. The tooth member 110 guides and holds the wire to the fastener shank. The stop pin 100 restricts the longitudinal movement of the bit assembly 70 to the extent the stop pin 100 slides within the bit shaft groove 96.

FIG. 10 is a top view of the working end 34 of the safety tube 30 of FIG. 9.

FIG. 11 is a front elevation sectional view of the safety tube 30 of the wire hooking tool in FIG. 4 with the spring element 64 compressed, the outer rim 42 encasing the fastener head, the tooth member 110 holding the wire against the fastener shank, the pressure of the outer rim 42 exerted against the wire preventing the wire from slipping, and the safety tube 30 rotated such that the wire is hooked at about a 50 degree angle.

FIG. 12 is a top view of the working end 34 of FIG. 11.

FIG. 13 is a front elevation sectional view of the safety tube 30 of the wire hooking tool in FIG. 4 with the spring element 64 compressed, the outer rim 42 encasing the fastener head, the tooth member 110 holding the wire against the fastener shank, the pressure of the outer rim 42 exerted against the wire preventing the wire from slipping, and the safety tube 30 rotated such that the wire is hooked at about a 170 degree angle.

FIG. 14 is a top view of the working end 34 of the safety tube 30 of FIG. 13.

FIG. 15 is a front elevation sectional view of the safety tube 30 of the wire hooking tool in FIG. 4 with the spring element 64 compressed, the outer rim 42 encasing the fastener head, the tooth member 110 holding the wire against the fastener shank, the pressure of the outer rim 42 exerted against the wire preventing the wire from slipping, and the safety tube 30 rotated such that the wire is fully hooked around the fastener shank. At this stage, release of a small amount of pressure on the handle 20 causes the spring element 64 to recoil thus causing the bit assembly 70 to protrude outwardly so as to allow further rotation of the safety tube 30 to tighten the fastener without interference from the tooth member 110, but with the additional support provided by the encasement of the fastener head by the outer rim 42.

FIG. 16 is a top view of a working end 34 of the safety tube 30 of FIG. 15.

The applicant intends to encompass within the language any structure presently existing or developed in the future that performs the same function. In the claims, any means-plus-function clause is intended to cover the structures described herein as performing the recited function and, not only structural equivalents, but also equivalent structures. Other substitutions, modifications, changes and/or omissions may be made in the design, operating conditions and arrangement of the preferred and other exemplary embodiments without departing from the spirit of the present invention.

What is claimed is:

1) A multi-purpose tool comprising:
(a) a handle having a connecting end, said handle defining a longitudinal axis;
(b) a safety tube having a connecting end coupled with said connecting end of said handle, and a working end at an opposite end, said safety tube comprising:
i) safety tube interior walls;
ii) a bit assembly housing defined by at least a portion of said safety tube interior walls that is at said working end of said safety tube, said bit assembly housing having an inner housing end that is between said connecting end of said safety tube and said working end, said bit assembly housing comprising a securing hollow that extends outwardly from said inner housing end; and
iii) wall edges at said working end defining an outer rim; and
(c) a spring element having a first end adjacent to said inner housing end and a second end at an opposite end, said bit assembly housing being capable of receiving said spring element at said working end;
(d) a bit assembly comprising:
i) a securing member having a first end adjacent to said second end of said spring element and a second end at an opposite end, said securing member having a shape and size that is complementary to a shape and size of said securing hollow wherein said securing hollow is capable of receiving and securing said securing member such that said bit assembly rotates as said safety tube is rotated; and
ii) a bit element coupled with said second end of said securing member; and
(e) a wire rotation means that is adapted for engaging a wire and rotating said wire clockwise and counterclockwise around a fastener shank.

2) A multi-purpose tool in accordance with claim 1, wherein said wire rotation means is adapted to engage different types of wires including an electrical wire, a telephone wire, a computer wire, an automobile wire, a vehicle wire, an airplane wire, an appliance wire, an equipment wire, a stereo speaker wire, a multi-strand wire, a combination of wires, a strand, a cloth strip, a thread strip, a fiber strip, a metal strip, and a combination of strips.

3) A multi-purpose tool in accordance with claim 1, wherein said fastener is selected from a group consisting of a screw, a dowel and a bolt.

4) A multi-purpose tool in accordance with claim 1, wherein said bit assembly further comprises a spring guide having a proximal end and a distal end, said spring guide being an elongated member cylindrical in shape, said spring guide capable of being received by a hollow at said second end of said spring element, said distal end of said spring guide being coupled with said first end of said securing member.

5) A multi-purpose tool in accordance with claim 1, wherein said bit element comprises:
(a) a bit shaft having a first end at one end coupled with said second end of said securing member and a second end at an opposite end, said bit shaft being an elongated member; and
(b) a bit having a connecting end coupled with said second end of said bit shaft and a bit tip at an opposite end, said bit tip being adapted for engaging a fastener head for rotating a fastener, said bit tip comprising a plurality of screwdriver bit tips.

6) A multi-purpose tool in accordance with claim 1, wherein said bit element comprises:
(a) a bit shaft having a first end at one end coupled with said second end of said securing member and a second end at an opposite end, said bit shaft being an elongated member; and
(b) a bit having a connecting end coupled with said second end of said bit shaft and a bit tip at an opposite end, said bit tip being adapted for engaging a fastener head for rotating a fastener, said bit tip being other than a phillips head.

7) A multi-purpose tool in accordance with claim 1, wherein a circumference of said safety tube inner walls extending from said connecting end of said safety tube outwardly to said inner housing end is less than a circumference of an outer perimeter of said spring element, thereby providing support for said spring element such that said spring element does not extend inwardly beyond said inner housing end.

8) A multi-purpose tool in accordance with claim 1, wherein said safety tube has a solid core portion extending longitudinally from said connecting end of said safety tube outwardly to said inner housing end, said solid core providing support for said spring element such that said spring element does not extend inwardly beyond said inner housing end.

9) A multi-purpose tool in accordance with claim 1, wherein:
(a) said bit element comprises:
i) a bit shaft having a first end at one end coupled with said second end of said securing member and a second end at an opposite end, said bit shaft being an elongated member; and
ii) a bit having a connecting end coupled with said second end of said bit shaft and a bit tip at an opposite end, said bit tip comprising a plurality of screwdriver bit tips, whereby said bit tip is adapted for engaging a fastener head for rotating a fastener; and
(b) an inner circumference of said outer rim is of a predetermined shape and size sufficient to surround said fastener head so as to provide additional support to prevent said bit tip from slipping off said fastener head as said safety tube is rotated.

10) A multi-purpose tool in accordance with claim 1, wherein said wire rotation means includes a tooth member protruding longitudinally beyond said outer rim, said tooth member being substantially rectangular in shape, said tooth member being capable of rotating said wire clockwise and counterclockwise around said fastener shank as said safety tube is rotated and a pressure is exerted on said handle toward a fastener thereby compressing said spring element and recessing said bit assembly inwardly.

11) A multi-purpose tool in accordance with claim 1, wherein:
(a) said securing hollow has a proximal end adjacent to said inner housing end and a distal end; and
(b) said bit assembly housing further comprises a non-securing hollow extending from said distal end of said securing hollow outwardly to said outer rim, said non-securing hollow being substantially circular in shape.

12) A multi-purpose tool in accordance with claim 1, wherein said securing hollow is hexagonal in shape.

13) A multi-purpose tool in accordance with claim 1, wherein:
(a) said bit element comprises a bit shaft at one end and a bit tip at an opposite end, said bit shaft being magnetic for a known length; and
(b) said securing member has a magnetic bit element securing hollow having an interior surface contoured for engagement with a known length of said bit shaft, said bit shaft showing a magnetic attraction to said magnetic bit element securing hollow such that said magnetic bit element securing hollow holds said bit element when engaged.

14) A multi-purpose tool in accordance with claim 1, wherein said bit element comprises a bit shaft at one end and a bit tip at an opposite end, said bit tip showing a magnetic attraction to a fastener head such that said bit tip better holds to said fastener head when engaged.

15) A multi-purpose tool in accordance with claim 1, wherein:
(a) said bit element comprises:
i) a bit shaft having a first end at one end coupled with said second end of said securing member and a second end at an opposite end, said bit shaft being an elongated member; and
ii) a bit having a connecting end coupled with said second end of said bit shaft and a bit tip at an opposite end, said bit tip comprising a plurality of screwdriver bit tips, whereby said bit tip is adapted for engaging a fastener head for rotating a fastener; and
(b) said tool further comprises:
i) a bit shaft groove extending longitudinally on said bit shaft; and
ii) a circular threaded hole in a wall on said safety tube;
iii) a stop pin having an elongated threaded member, said stop pin having a shape and size that is complementary to a shape and size of said circular threaded hole, said stop pin having a shape and size that is complementary to a shape and size of said bit shaft groove, said stop pin capable of being threaded through said circular threaded hole and protruding into said bit shaft groove, thereby allowing a longitudinal movement of said bit assembly to an extent said stop pin slides within said bit shaft groove.

16) A multi-purpose tool in accordance with claim 1, wherein:
(a) said bit element comprises:
i) a bit shaft having a first end at one end coupled with said second end of said securing member and a second end at an opposite end, said bit shaft being an elongated member; and
ii) a bit having a connecting end coupled with said second end of said bit shaft and a bit tip at an opposite end, said bit tip comprising a plurality of screwdriver bit tips, whereby said bit tip is adapted for engaging a fastener head for rotating a fastener; and
(b) said tool further comprises:
i) a stop pin slit extending longitudinally in a wall on said safety tube;
ii) at least one circular threaded bore located in said bit shaft; and
iii) a stop pin having an elongated threaded member, said stop pin having a shape and size complementary to a shape and size of said stop pin slit, said stop pin having a shape and size complementary to a shape and size of and said circular threaded bore, said stop pin being capable of extending through said stop pin slit and threaded into said circular threaded bore thus allowing a longitudinal movement of said bit assembly to an extent said stop pin slides within said stop pin slit.

17) A multi-purpose tool in accordance with claim 1, further comprising:
(a) a safety tube slit in said safety tube extending longitudinally inwardly from said outer rim, said safety tube slit having longitudinal grooves along both sides;
(b) a retractable adjustment device having a knob end and a circular tube end at an opposite end, said retractable adjustment device comprising:
i) a circular tube extending from said circular tube end inwardly, said circular tube having interior walls that have a shape and size that is complementary to a shape and size of exterior walls of said safety tube, said circular tube being capable of fitting snugly around said safety tube;
ii) an adjustment knob coupled at one end to said circular tube and coupled an opposite end to said handle;
(c) a snap ring groove extending transversely around said safety tube;
(d) a snap ring having an opening that is complementary to said safety tube slit, said snap ring having a shape and size that is complementary to said snap ring groove, whereby said snap ring groove is capable of receiving said snap ring and securing said retractable adjustment device against said handle;
(e) said wire rotation means comprises a retractable tooth having a connecting end and a retractable tooth bit tip at an opposite end, said retractable tooth being elongated and substantially rectangular in shape, said retractable tooth having a flat side and narrow sides adjacent to said flat side, said narrow sides having a thickness that is complementary to a width of said longitudinal grooves of said safety tube slit, said retractable tooth having a solid pin coupled perpendicularly to said flat side at said connecting end of said retractable tooth, said longitudinal grooves being capable of receiving said narrow sides of said retractable tooth, said retractable tooth bit tip comprising a plurality of screwdriver bit tips;
(f) a positioning slit extending obliquely in said circular tube, said positioning slit being at a 22 degree angle or other angle sufficient to support its intended purposes of receiving said solid pin, pushing and pulling said solid pin along a longitudinal axis as said adjustment knob is rotated, thereby allowing said retractable tooth to extend outwardly and inwardly;
(g) a plurality of positioning slit notches in a side edge of said positioning slit near said adjustment knob, said positioning slit notches being capable of holding said solid pin at a desired setting;
(h) a strap spring received on an interior of said positioning slit, said strap spring being capable of maintaining tension on said solid pin so as to secure said solid pin in said positioning slit notches; and
(i) strap spring supports, one at each end of said strap spring, said strap spring supports being received by one or more inner wall indentations in a side edge of said positioning slit, thereby holding said strap spring in place.

18) A multi-purpose tool comprising:
(a) a handle having a connecting end, said handle defining a longitudinal axis;
(b) a safety tube having a connecting end coupled with said connecting end of said handle, and a working end at an opposite end, said safety tube comprising:
i) safety tube interior walls;
ii) a bit assembly housing defined by at least a portion of said safety tube interior walls that is at said working end of said safety tube, said bit assembly housing having an inner housing end that is between said connecting end of said safety tube and said working end; and
iii) wall edges at said working end defining an outer rim; and
(c) a spring element having a first end adjacent to said inner housing end and a second end at an opposite end, said bit assembly housing being capable of receiving said spring element at said working end;
(d) a bit assembly comprising:
i) a spring guide having a proximal end and a distal end, said spring guide being an elongated member cylindrical in shape, said spring guide capable of being received by a hollow at said second end of said spring element;
ii) a bit element having a flat head screwdriver bit shaft at one end coupled to said distal end of said spring guide and a flat head screwdriver bit tip at an opposite end, said flat head screwdriver bit shaft being an elongated member, said flat head screwdriver bit tip having a flat head thus forming narrow opposing sides; and
(e) said tool further comprises:
i) a band coupled transversely with an outer perimeter of said flat head screwdriver bit shaft;
ii) a first band restricting hollow having a proximal end and a distal end, said first band restricting hollow extending inwardly from a predetermined distance from said outer rim, said first band restricting hollow being substantially circular in shape, said first band restricting hollow having an inner circumference less than an outer circumference of said band and greater than an outer circumference of said flat head screwdriver bit shaft;
iii) a band slide hollow having a distal end and a proximal end, said band slide hollow extending inwardly from said proximal end of said first band restricting hollow for a predetermined distance, said band slide hollow having an inner circumference at least as great as said outer circumference of said band, said band slide hollow being capable of receiving said band;
(f) a second band restricting hollow extending inwardly from said proximal end of said band slide hollow, said second band restricting hollow being substantially circular in shape, said second band restricting hollow having an inner circumference less than said outer circumference of said band and greater than said outer circumference of said flat head screwdriver bit shaft, thereby restricting longitudinal movement of said bit assembly to an extent that said band is restricted between said first band restricting hollow and said second band restricting hollow;
i) at least one pair of flat head bit guide slots, each pair of flat head bit guide slots having a first bit guide slot and a second bit guide slot that is at an opposite interior wall of said safety tube, said first bit guide slot and said second bit guide slot extending longitudinally inwardly on said safety tube interior walls from said outer rim, said first bit guide slot and said second bit guide slot having a distal end near said outer rim and a proximal end, said first bit guide slot and said second bit guide slot having a size and shape complementary to a shape and size of said narrow opposing sides of said flat head screwdriver bit tip such that said proximal end of said first bit guide slot and said proximal end of said second bit guide slot are capable of receiving said narrow opposing sides when said spring element is compressed; and
(g) a wire rotation means that is adapted for engaging a wire and rotating said wire clockwise and counterclockwise around a fastener shank.

19) A multi-purpose tool for tightening and loosening a fastener with an additional support means, and for optionally and simultaneously hooking and unhooking a wire around said fastener, the tool comprising:
(a) a handle having a connecting end, said handle defining a longitudinal axis;
(b) a safety tube having a connecting end coupled with said connecting end of said handle, and a working end at an opposite end, said safety tube comprising:
i) safety tube interior walls;
ii) a bit assembly housing defined by at least a portion of said safety tube interior walls that is at said working end of said safety tube, said bit assembly housing having an inner housing end that is between said connecting end of said safety tube and said working end, said bit assembly housing comprising a securing hollow that extends outwardly from said inner housing end; and
iii) wall edges at said working end defining an outer rim; and
(c) a spring element having a first end adjacent to said inner housing end and a second end at an opposite end, said bit assembly housing being capable of receiving said spring element at said working end;
(d) a bit assembly comprising:
i) a spring guide having a proximal end and a distal end, said spring guide being an elongated member cylindrical in shape, said spring guide capable of being received by a hollow at said second end of said spring element;
ii) a securing member having a first end that is coupled with said distal end of said spring guide, and a second end at an opposite end, said securing member having a shape and size that is complementary to a shape and size of said securing hollow, said securing hollow being capable of receiving and securing said securing member such that said bit assembly rotates as said safety tube is rotated; and
iii) a bit element comprising:
(1) a bit shaft having a first end at one end coupled with said second end of said securing member and a second end at an opposite end, said bit shaft being an elongated member; and
(2) a bit having a connecting end coupled with said second end of said bit shaft and a bit tip at an opposite end, said bit tip comprising a plurality of screwdriver bit tips that are adapted for engaging and rotating said fastener head; and
(e) a tooth member protruding longitudinally outwardly beyond a contiguous portion of said outer rim, said tooth member being capable of engaging a wire and turning said wire clockwise and counterclockwise around a fastener shank;
(f) a stopping means for limiting a longitudinal movement of said bit assembly inwardly and outwardly; and
(g) a spring supporting means for providing support against which said spring element can compress, thereby preventing said spring element and said spring guide from recessing longitudinally inwardly beyond said inner housing end.

20) A multi-purpose tool in accordance with claim 20, wherein said spring supporting means is a solid core portion of said safety tube extending from said connecting end of said safety tube to said inner housing end.

21) A method of hooking and unhooking a wire around a fastener, and for optionally and simultaneously tightening and loosening said fastener with an additional support, comprising:
(a) providing a multi-purpose tool having a handle, a safety tube having a connecting end coupled to said handle and a working end that receives a bit assembly, and an outer rim defined by wall edges at said working end;
(b) a bit assembly extension means for extending said bit assembly longitudinally outwardly beyond said outer rim and for allowing said bit assembly to retract inwardly; and
(c) a wire rotation means that is adapted for optionally engaging a wire and rotating said wire clockwise and counterclockwise around a fastener shank.
